(19) United States
(12) Patent Application Publication
(10) Pub. No.: US 2026/0369122 A1
(43) Pub. Date: Nov. 19, 2026

(54) GAMING SYSTEM AND METHOD WITH TRANSFORMING SYMBOL AND PROGRESSIVE METER FEATURE

(71) Applicant: LNW Gaming, Inc., Las Vegas, NV (US)

(72) Inventors: Amy ROBARDS, Sparks, NV (US); Kellen DALE, Reno, NV (US); Emily HVEGHOLM, Sparks, NV (US); Dougal AUSTIN, Reno, NV (US); Danielle BYRNE, Sparks, NV (US); Bruce Lee CHOE, Reno, NV (US)

(21) Appl. No.: 19/672,866

(22) Filed: May 11, 2026

Related U.S. Application Data
(60) Provisional application No. 63/806,135, filed on May 15, 2025.

(51) Int. Cl. G07F 17/32

(52) U.S. Cl. CPC G07F 17/3213; G07F 17/3258; G07F 17/3265; G07F 17/3267

(57) ABSTRACT

A gaming system and method provide a hold-and-respin bonus feature wherein landed designated value-bearing symbols can transform into multiple symbol instances. These transformed instances contribute to player awards. At least one transformed instance, or the transformation event itself, contributes to incrementing a progressing award meter. During the feature, at least one of the transformed symbol instances is held on an array for subsequent respins. In some embodiments, one transformed instance is removed from the array after contributing to awards while another is held. A special symbol may trigger a secondary bonus feature, also potentially affecting the progressing award meter. A final award is based on values associated with held symbol instances.

### CROSS-REFERENCE TO RELATED APPLICATION(S)

This patent application claims priority benefit of U.S. Provisional Patent Application No. 63/806,135 filed May 15, 2025, which is incorporated herein by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2025, LNW Gaming, Inc.

### FIELD OF THE INVENTION

The present invention relates to a technological improvement to gaming systems, gaming machines, and methods and, more particularly, to new and improved game mechanics including transforming symbols that contribute to player awards and a progressively incrementing award meter within a hold-and-spin style bonus feature.

### BACKGROUND OF THE INVENTION

The gaming industry depends upon player participation. Players are generally “hopeful” players who either think they are lucky or at least think they can get lucky – for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple bonus features with different game formats, and multiple random outcome determinations per feature. The game formats may, for example, include picking games, reel spins, wheel spins, and other arcade-style play mechanics. Inefficiencies in processor execution of the game software can slow play of the game and prevent a player from playing the game at their desired pace.

Yet another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

While existing games offer various features, there remains a continuous need to develop novel game mechanics that enhance player engagement and provide new forms of entertainment. Specifically, in features like Hold-and-Spin (HnS) or respin bonuses, where symbols are held on the reels for subsequent spins to accumulate value, introducing more dynamic symbol behaviors and interactive award progression can significantly improve the player experience. Therefore, there is a need for improved HnS features with more engaging symbol interactions and award progression mechanics that provide clear and exciting paths to winning.

### SUMMARY OF THE INVENTION

The present invention provides a gaming system, gaming machine, and method featuring an enhanced Hold-and-Spin (HnS) style bonus game. During this bonus game, when specific value-bearing symbols land on the display, they may transform into multiple symbol instances, such as a first transformed symbol instance and a second transformed symbol instance. These transformed instances contribute to player awards in various ways.

In one primary embodiment, both the first and second transformed symbol instances are presented and held on the display. Both instances may contribute to an immediate win amount, and one of the held transformed instances additionally contributes a value portion, or a predetermined amount, to increment a progressing award meter, such as a jackpot. The other held transformed instance may contribute to a separate collection mechanism for a different significant award.

In an alternate embodiment, upon transformation into first and second transformed symbol instances, one of these instances (e.g., the second) may contribute to player awards and the progressing award meter and is then removed from the display, for example, by animating off the game array. The other transformed instance (e.g., the first) is held on the display for subsequent accumulation and contribution to the final bonus award.

Regardless of the specific behavior where one or both transformed instances are held, the HnS feature continues with respins, allowing more value-bearing symbols to land and potentially transform, thereby incrementing winnings and the progressing award meter. Furthermore, a special feature-trigger symbol may activate a secondary bonus feature. This secondary feature offers additional chances to win and can also allow for further increments to the progressing award meter, potentially awarding the accumulated value in the progressing award meter if a specific outcome, such as filling all available symbol positions, is achieved. This system aims to enhance player engagement by providing dynamic symbol interactions with various outcomes for transformed symbols, and a visibly progressing award meter that grows with specific symbol events, offering multiple avenues to achieve significant awards. Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a front view of a free-standing gaming machine according to an embodiment of the present invention.

FIG. 2 is a block diagram of a gaming system according to an embodiment of the present invention.

FIGS. 3A-3C are a flow diagram for a data processing method that corresponds to instructions executed by a controller for the game with transforming symbols and a progressive award feature, according to an embodiment of the present invention.

FIG. 4 illustrates an exemplary screen display of a value-bearing symbol landing in the game array.

FIG. 5 illustrates an exemplary screen display of the value-bearing symbol transforming into two distinct symbol instances.

FIG. 6 illustrates an exemplary screen display of one of the transformed symbol instances contributing to the progressing award meter.

FIG. 7 illustrates an exemplary screen display of multiple value-bearing symbols and a separate collection meter.

FIG. 8 illustrates an exemplary screen display of a special feature-trigger symbol landing to initiate a secondary bonus feature.

FIG. 9 illustrates an exemplary screen display of a secondary bonus feature, potentially showing a condition for winning the progressing award.

FIG. 10 illustrates an exemplary screen display of an alternate embodiment wherein, after transformation, one transformed symbol instance animates off the game array.

FIG. 11 illustrates an exemplary screen display of an alternate embodiment wherein the progressing award meter increments in connection with the symbol instance that animated off the array, and the other transformed symbol instance remains on the array.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.” For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

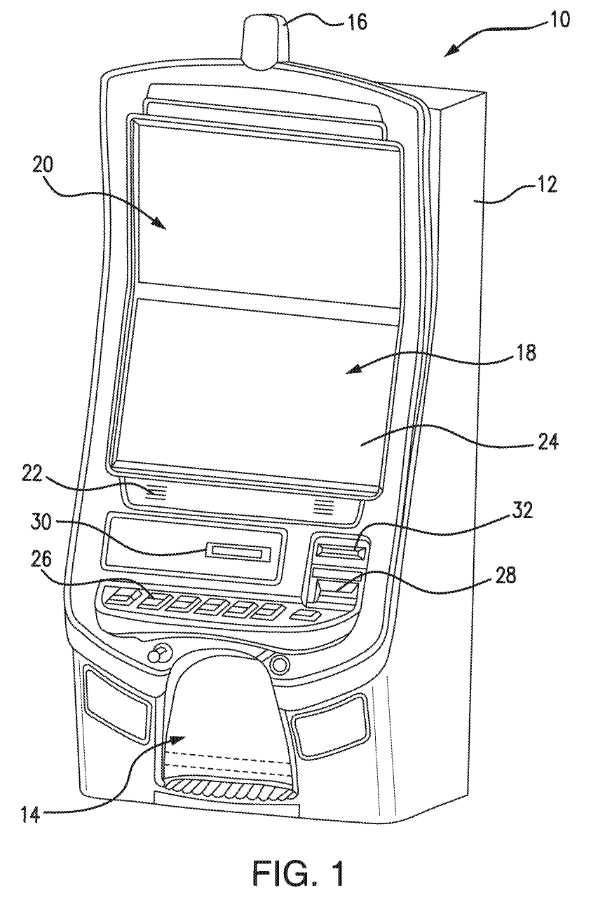

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in US Patent Nos. 6,517,433, 8,057,303, and 8,226,459, which are incorporated herein by reference in their entireties. The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. A notification mechanism 16, such as a candle or tower light, is mounted to the top of the cabinet 12. It flashes to alert an attendant that change is needed, a hand pay is requested, or there is a potential problem with the gaming machine 10. The input devices, output devices, and input/output devices are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Patent No. 6,517,433, a transmissive video display is disposed in front of the mechanical-reel display to portray a video image superimposed upon electro-mechanical reels. In another combination disclosed in U.S. Patent No. 7,654,899, a projector projects video images onto stationary or moving surfaces. In yet another combination disclosed in U.S. Patent No. 7,452,276, miniature video displays are mounted to electro-mechanical reels and portray video symbols for the game. In a further combination disclosed in U.S. Patent No. 8,591,330, flexible displays such as OLED or e-paper displays are affixed to electro-mechanical reels. The aforementioned U.S. Patent Nos. 6,517,433, 7,654,899, 7,452,276, and 8,591,330 are incorporated herein by reference in their entireties. The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information. The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) mounted over the primary or secondary presentation devices, an input deck 24 supporting a video button panel 26 bearing touch keys and one or more mechanical push-buttons 28, a bill/ticket acceptor 30, a card reader/writer (not shown), a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts. The player input devices, such as the touch screen, video button panel 26, push-buttons 28, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player’s desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element. The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credit” meter. The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 30, a card reader/writer (not shown), a wireless communication interface for reading cash or credit data from a nearby mobile device, and a network interface for withdrawing cash or credits from a remote account via an electronic funds transfer. In response to a cashout input that initiates a payout from the credit balance on the “credit” meter, the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, a card reader/writer, the ticket dispenser 32 for printing tickets redeemable for cash or credits, a wireless communication interface for transmitting cash or credit data to a nearby mobile device, and a network interface for depositing cash or credits to a remote account via an electronic funds transfer.

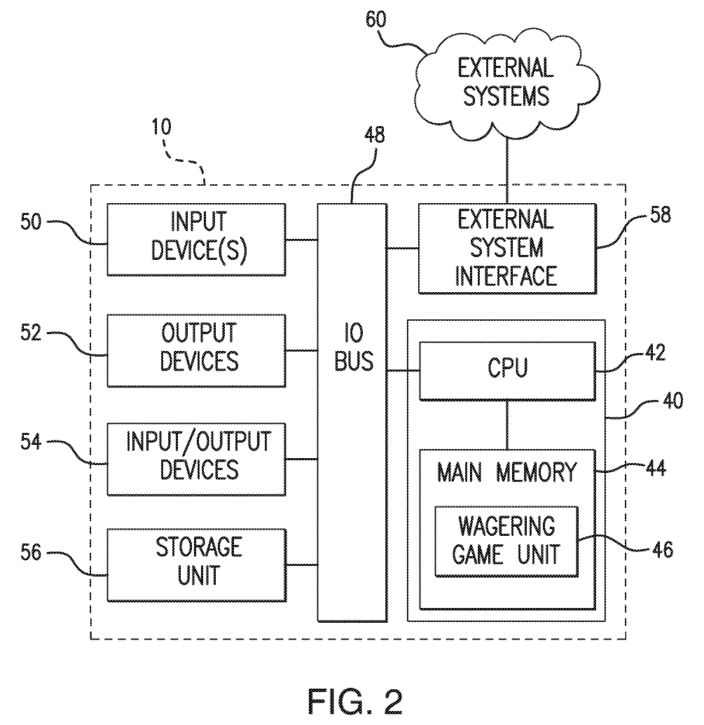

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part. The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks). The external system 60 includes, in various aspects, a gaming network, other gaming machines or terminals, a gaming server, a remote controller, communications hardware, or a variety of other interfaced systems or components, in any combination. In yet other aspects, the external system 60 comprises a player’s portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.). The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not. When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game. The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card. The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc. In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player’s pressing of a “Spin” touch key or button, into an electronic data signal indicative of an instruction relating to the wagering game (e.g., an electronic data signal bearing data on a wager amount). In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter. In one embodiment, the gaming machine 10 and, additionally or alternatively, the external system 60 (e.g., a gaming server), means gaming equipment that meets the hardware and software requirements for fairness, security, and predictability as established by at least one state’s gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 10 may be regulatorily approved and thus implemented with hardware and software architectures, circuitry, and other special features that differentiate it from general-purpose computers (e.g., desktop PCs, laptops, and tablets).

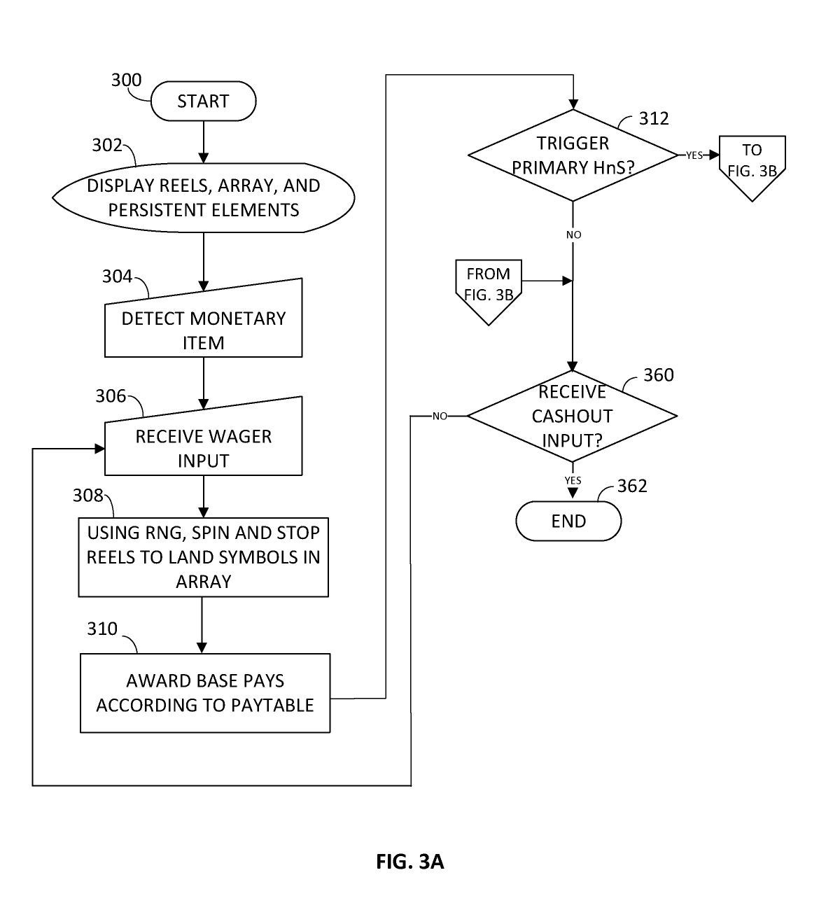

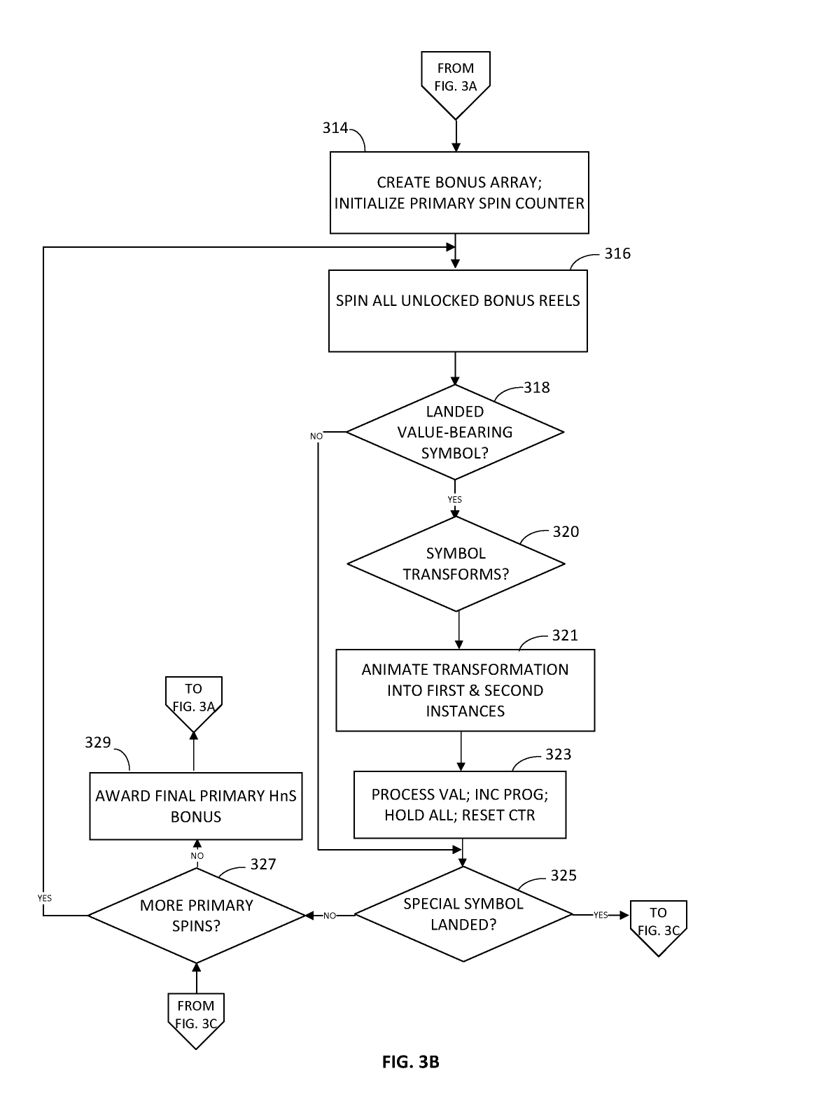

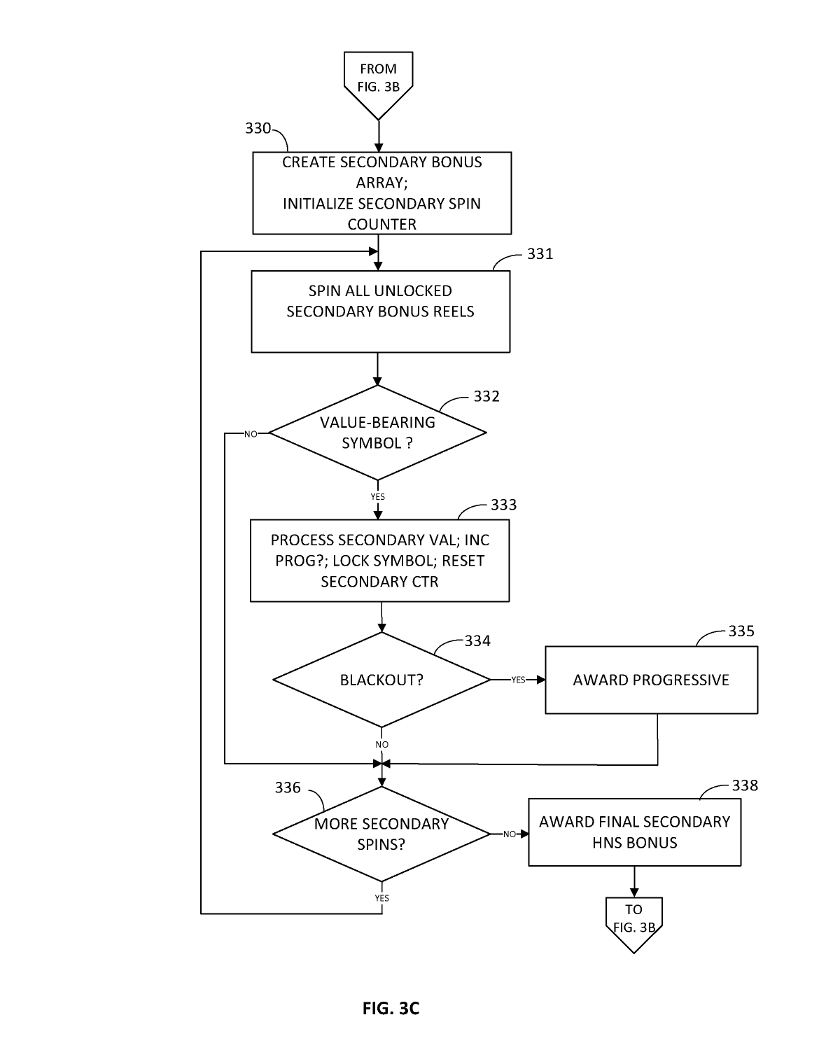

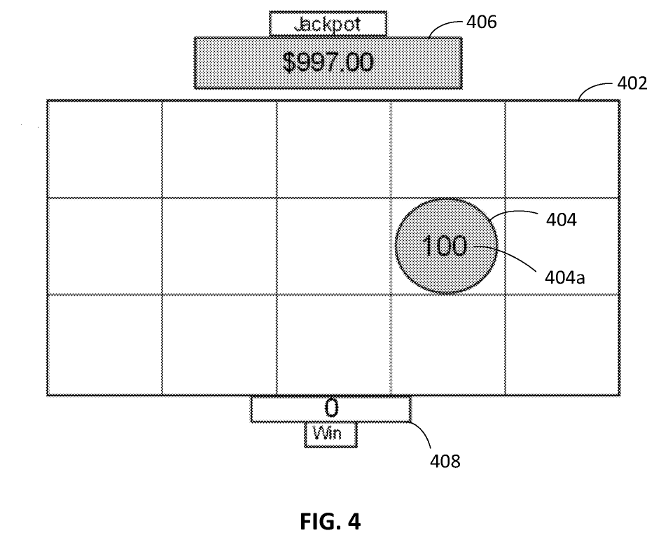

Referring now to FIGS. 3A-3C, there is shown a flow diagram representing one data processing method corresponding to at least some instructions stored and executed by the game-logic circuitry 40 in FIG. 2 to perform operations for the game with transforming symbols and a progressive award feature, according to an embodiment of the present invention. The data processing method is described below in connection with the exemplary presentations of game outcomes in FIGS. 4-9.

The data processing method commences at step 300. At step 302, the game-logic circuitry 40 controls one or more presentation devices (e.g., primary presentation device 18) to display a game interface, including symbol-bearing reels within an array (e.g., array 402 in FIG. 4), and persistent elements such as a progressing award meter (e.g., progressing award meter 406 in FIG. 4) and a win meter (e.g., win meter 408 in FIG. 4). At step 304, the game-logic circuitry 40 detects, via a value input device (e.g., bill/ticket acceptor 30), a physical item associated with a monetary value that establishes a monetary balance on a credit meter. At step 306, the game-logic circuitry 40 receives a wager input from a player, for example, via the input deck 24 or touch screen functionality on the primary presentation device 18. At step 308, the game-logic circuitry 40, using an RNG, causes the reels to spin and stop, landing symbols from the reels in the array 402. At step 310, the game-logic circuitry 40 awards any standard payouts according to a paytable based on the landed symbols in the base game.

At decision step 312, the game-logic circuitry 40 determines if a primary Hold-and-Spin (HnS) style bonus feature has been triggered. This may occur by landing a predetermined number or combination of special symbols, including initial value-bearing trigger symbols. If not triggered (NO at 312), the method proceeds to check for a cashout request at step 360. If the primary HnS bonus is triggered (YES at 312), the method proceeds to step 314 (FIG. 3B).

At step 314, the game-logic circuitry 40 creates or initiates the primary HnS bonus array (which may be the same as the base game array 402) and initializes a primary HnS spin counter (e.g., to a predetermined number of respins such as three). Triggering symbols are typically held in their positions. At step 316, the game-logic circuitry 40 spins any unlocked reel positions in the HnS bonus array. At decision step 318, it is determined if one or more designated value-bearing symbols (e.g., value-bearing symbol 404 in FIG. 4) have landed in the array 402. If no new designated value-bearing symbols land (NO at 318), the method proceeds to check if a special symbol landed (step 325). If a designated value-bearing symbol lands (YES at 318), the method proceeds to decision step 320.

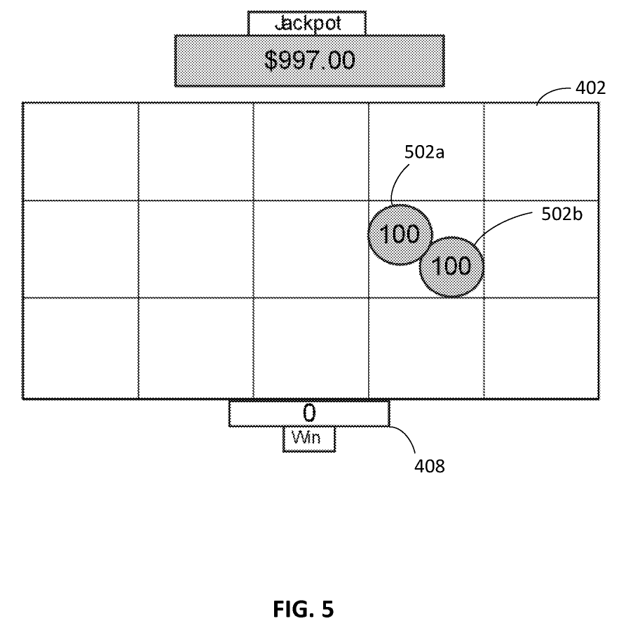

At decision step 320, it is determined if the landed value-bearing symbol 404 is designated to transform or split. This can be based on a random chance, a predefined characteristic of the symbol, or other game logic. If the symbol does not transform (NO at 320), the method proceeds to process the symbol at step 323 (assuming non-transforming value symbols are also held and reset spins). If the value-bearing symbol transforms (YES at 320), at step 321, the game-logic circuitry 40 animates the transformation or splitting of the value-bearing symbol 404 into two or more distinct symbol instances, for instance, a first transformed symbol 502a and a second transformed symbol 502b, as depicted in FIG. 5. Both may initially show the same value as the original symbol or predetermined values. Following the animation at 321, the method proceeds to step 323.

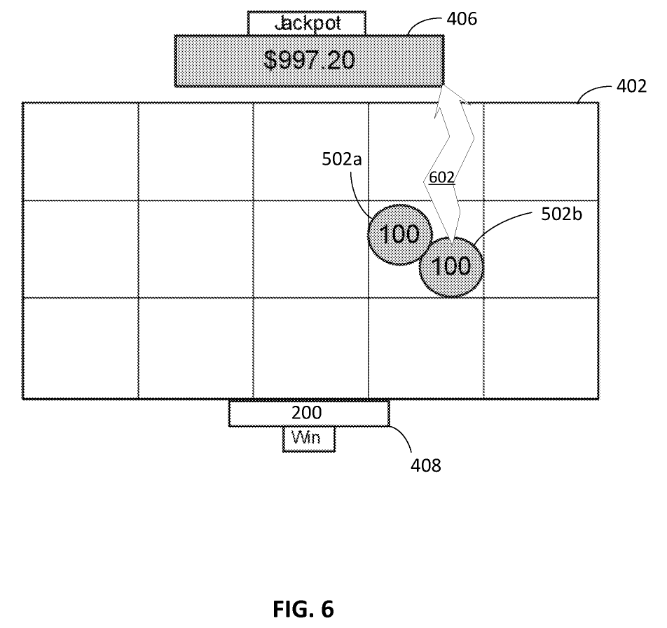

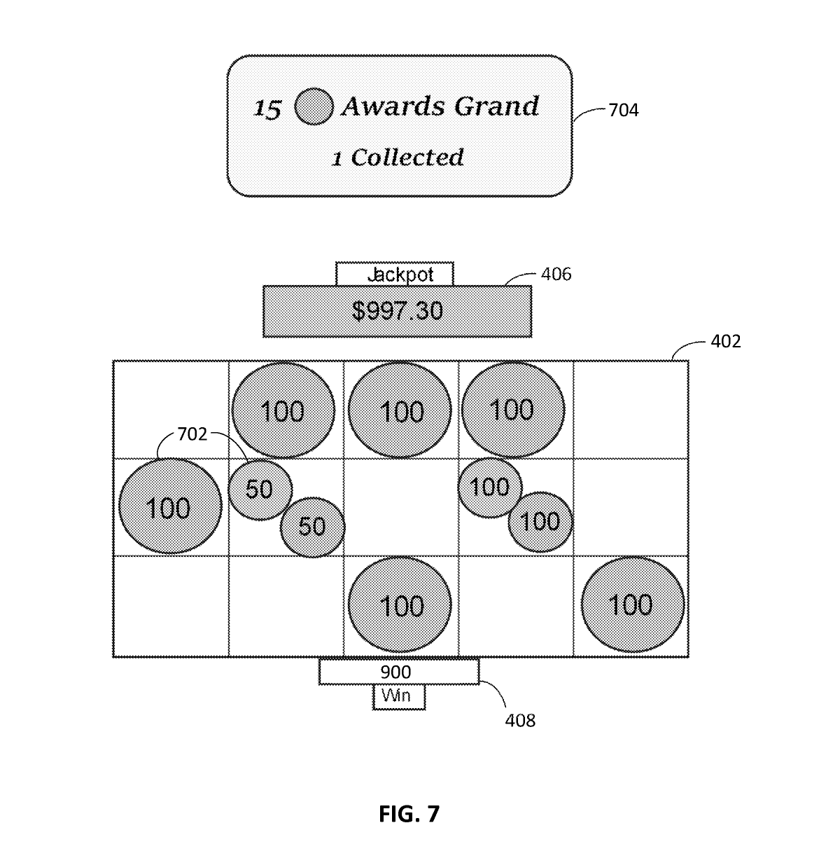

At step 323, the game-logic circuitry 40 processes the landed value-bearing symbol (whether transformed or not). In the preferred embodiment illustrated in FIG. 6, where transformation occurred, the values associated with the transformed instances (e.g., 502a, and 502b) are added to the win meter 408. Additionally, a portion of the value of the second transformed symbol 502b (or another designated transformed symbol instance remaining on the array) is used to increment the progressing award meter 406, as shown in FIG. 6 where a visual indication 602 may illustrate this contribution from the symbol 502b still on the array. All landed designated value-bearing symbols and their transformed instances (502a, 502b in this example) are held in their positions for the remainder of the primary HnS bonus, and the HnS spin counter is typically reset. FIG. 7 shows a later game state where array 402 holds multiple landed/transformed value-bearing symbols 702, and potentially a separate collection meter 704 has been incremented. After processing the symbol(s) at step 323, the method proceeds to step 325.

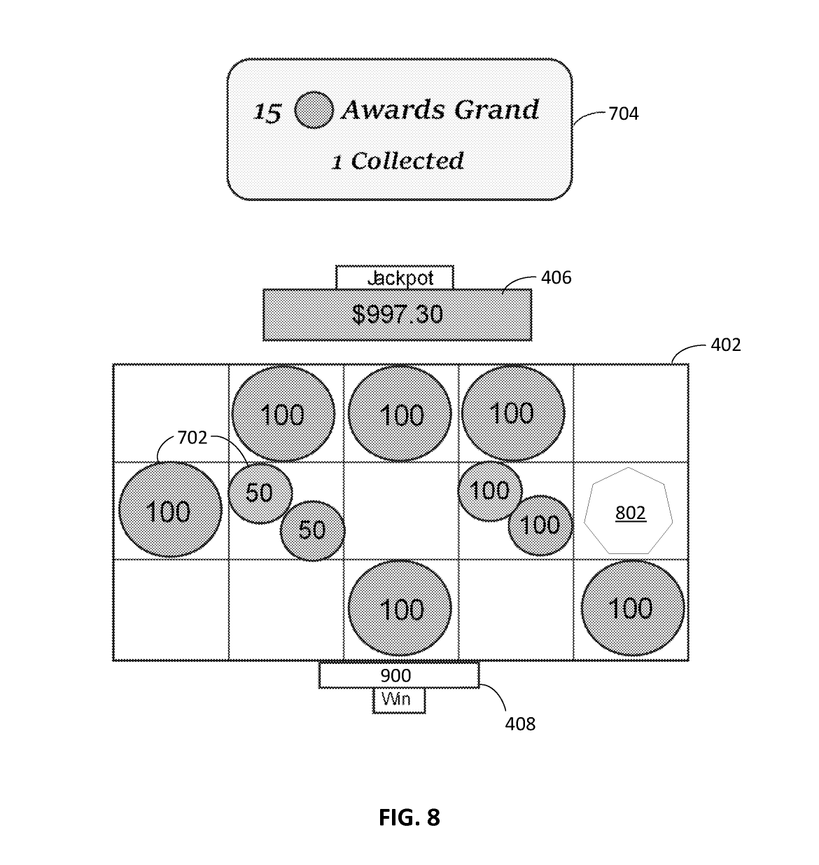

During the primary HnS feature, at decision step 325 (reached following step 323 or the NO path from 318), the game-logic circuitry 40 determines if a special feature-trigger symbol (e.g., symbol 802 in FIG. 8) has landed. This special symbol is configured to trigger a secondary bonus feature. If not (NO at 325), the method proceeds to check for more primary HnS spins at step 327. If the special feature-trigger symbol lands (YES at 325), the secondary bonus feature is initiated, and the method proceeds to step 330 (FIG. 3C).

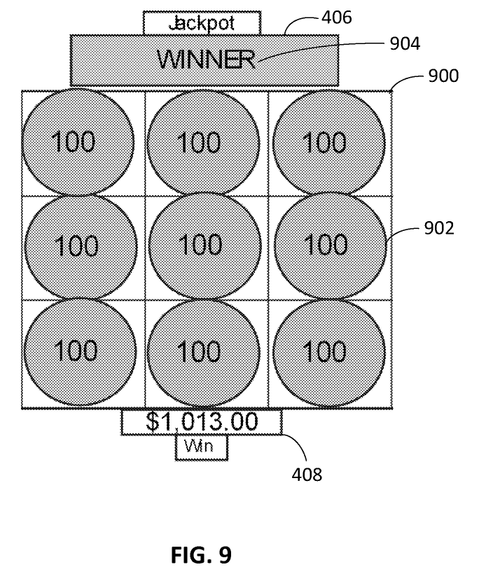

At step 330, the game-logic circuitry 40 creates or transitions to a secondary bonus feature array (e.g., array 900 in FIG. 9) and initializes a secondary bonus spin counter. At step 331, any unlocked positions in the secondary bonus feature array 900 are spun. At decision step 332, it is determined if any new value-bearing symbols land in the secondary bonus feature array. If no new symbols land (NO at 332), the method proceeds to check for more secondary spins at step 336. If yes (YES at 332), at step 333, their values are processed. This may include adding to the win meter 408. Furthermore, specific symbols landed in this secondary bonus feature can also contribute to incrementing the same progressing award meter 406. Landed symbols in the secondary bonus are locked, and the secondary bonus spin counter is reset. Following processing at 333, the method proceeds to check for a blackout condition at step 334.

At decision step 334, the game-logic circuitry 40 checks if a predetermined fill condition ("blackout") has occurred in the secondary bonus feature array 900 (i.e., all positions are filled with value-bearing symbols 902), as depicted in FIG. 9. If not (NO at 334), the method proceeds to check for more secondary spins at step 336. If such a fill condition occurs (YES at 334), at step 335, the game-logic circuitry 40 awards the total accumulated value displayed on the progressing award meter 406 (which may be indicated on a meter display 904). After awarding the progressive at 335, the method proceeds to check for more secondary spins at step 336.

At decision step 336, it is determined if there are more secondary bonus spins remaining. If yes (YES at 336), the method loops back to step 331 to spin the secondary reels again. If no more secondary bonus spins remain (NO at 336), at step 338, the final secondary bonus win (if any, beyond the progressive) is awarded, and the method returns to the primary HnS feature via the connector "TO FIG. 3B", proceeding to step 327.

Following the secondary bonus feature (via the input connector at step 327) or directly from step 325 (if no secondary trigger occurred), the method proceeds to decision step 327. At step 327, it is determined if more primary HnS spins remain. If yes (YES at 327), the method loops back to step 316 to spin the primary reels again. If no more primary HnS spins remain (NO at 327), at step 329, the total accumulated value from the held value-bearing symbols and their transformed instances in the primary HnS bonus is awarded and added to the win meter 408. Following the final award at 329, the method proceeds via connector "TO FIG. 3A" to the cashout check at step 360.

At step 360 (reached via NO from 312 or output from 329), the game-logic circuitry 40 determines if a cashout input has been received. If not (NO at 360), the method loops back to step 306 to await a new wager. If a cashout input is received (YES at 360), the game-logic circuitry 40 initiates a payout from the monetary balance. The method then ends at step 362.

In this description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

It is contemplated that the game mechanics described herein can be subject to various modifications and alternatives. For example, the conditions for a value-bearing symbol to transform or split can vary, including being dependent on the reel it lands on, adjacent symbols, or a random determination. The number of symbols a value-bearing symbol transforms into can be more than two. The contribution to the progressing award meter can be a fixed amount, a variable amount, or a percentage of the symbol's displayed value. The secondary bonus feature described with reference to FIGS. 8 and 9 could have different triggering mechanisms or different rules for awarding the progressing award meter. Different types of transformed symbols could have different behaviors or contribute to different meters or awards, such as the collection meter 704 shown in FIG. 7. The visual representation of the symbols and meters can also vary.

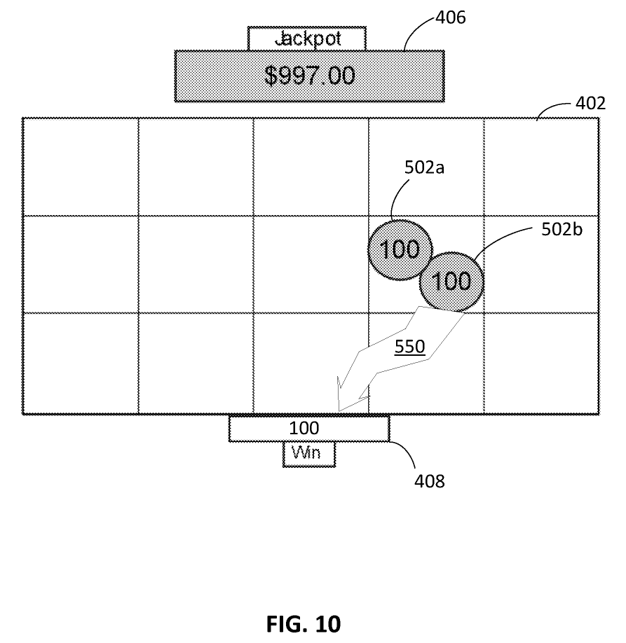

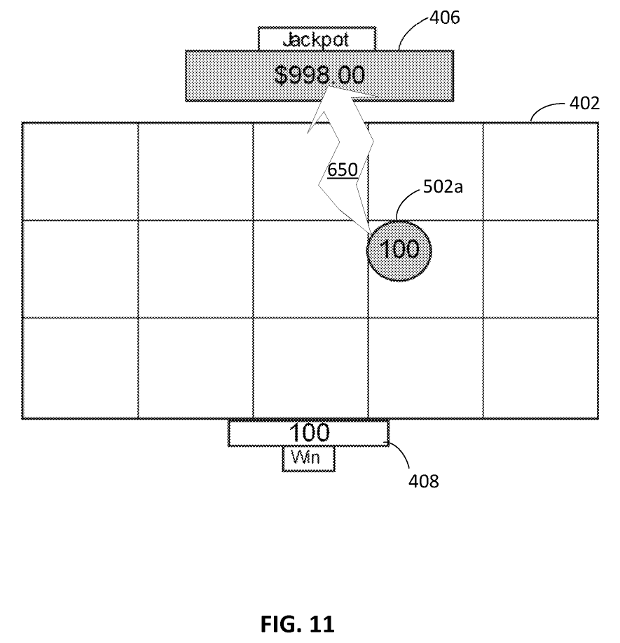

In an alternate embodiment, further illustrated in FIGS. 10 and 11, the transformation of a designated value-bearing symbol (e.g., 404 in FIG. 4) into a first transformed symbol instance (e.g., 502a) and a second transformed symbol instance (e.g., 502b) as shown in FIG. 5 may be followed by a different behavior for the transformed instances. As depicted in FIG. 10, upon transformation, the second transformed symbol instance 502b may be animated to move off (“fly off”) the main symbol array 402, indicated by an animation path 550, towards a win meter 408 or a temporary collection area (not shown). The value of this second transformed symbol instance 502b is added to the win meter 408. The first transformed symbol instance 502a remains in its position on the array 402 and is held.

Subsequent to the collection of the second transformed symbol instance 502b as shown in FIG. 10, FIG. 11 illustrates that the progressing award meter 406 is incremented. This increment may be based on the value of the collected second transformed symbol instance 502b, or alternatively, based on the value of the first transformed symbol instance 502a that remains on the array. A visual indication 650 may link this increment to the relevant symbol or collection event. In this embodiment, only the first transformed symbol instance 502a (the one that did not fly off) is held on the array 402 for subsequent respins of the hold-and-respin bonus feature, contributing its value to the final bonus award. This "fly-off" mechanic provides a different visual and interactive experience for the player, where one part of the transformed symbol is immediately collected for a direct win and contributes to the progressing award, while the other part is held for future accumulation.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence. Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A method of operating a gaming machine, the method comprising the operations of:
presenting, by a presentation assembly, a plurality of reels within an array and a progressing award meter, the plurality of reels bearing a plurality of symbols, the plurality of symbols including one or more designated value-bearing symbols;
initiating a hold-and-respin bonus feature in response to a trigger condition, the hold-and-respin bonus feature including a number of respins;
during a respin of the hold-and-respin bonus feature:
spinning and stopping at least a subset of the plurality of reels to land symbols from the plurality of symbols in the array; and
in response to landing at least one designated value-bearing symbol:
if at least one landed designated value-bearing symbol transforms into a plurality of transformed symbol instances, the plurality of transformed symbol instances including at least a first transformed symbol instance and a second transformed symbol instance, presenting the first transformed symbol instance and the second transformed symbol instance in the array; incrementing the progressing award meter by a value portion associated with at least one of the at least one landed designated value-bearing symbol, the first transformed symbol instance, or the second transformed symbol instance; and
holding the at least one landed designated value-bearing symbol and any of the transformed symbol instances in their positions in the array for subsequent respins of the hold-and-respin bonus feature; and
presenting, on the presentation assembly, an award based at least in part on values associated with all of the designated value-bearing symbols and the transformed symbol instances held in the array at the conclusion of the hold-and-respin bonus feature.

2. The method of claim 1, wherein the second transformed symbol instance is visually distinguishable from the first transformed symbol instance, and
wherein the progressing award meter is incremented by a value portion specifically associated with the second transformed symbol instance.

3. The method of claim 1, further comprising resetting a respin counter for the hold-and-respin bonus feature in response to landing the at least one designated value-bearing symbol or a transformed symbol instance thereof.

4. The method of claim 1, further comprising:
presenting a collection meter; and
incrementing the collection meter in response to collecting a predetermined type or number of symbols, the predetermined type or number of symbols including the first transformed symbol instance.

5. The method of claim 1, further comprising:
in response to landing a special feature-trigger symbol during the hold-and-respin bonus feature:
initiating a secondary bonus feature;
during the secondary bonus feature, enabling incrementing of the progressing award meter based on symbols landed in the secondary bonus feature; and
awarding an amount displayed on the progressing award meter if a predetermined fill condition is achieved in the secondary bonus feature.

6. The method of claim 1, wherein whether the at least one landed designated value-bearing symbol transforms is based on a random determination or a predefined characteristic of the at least one landed designated value-bearing symbol.

7. The method of claim 1, wherein both the first transformed symbol instance and the second transformed symbol instance contribute to a win amount for the hold-and-respin bonus feature, the contribution separate from the incrementing of the progressing award meter.

8. The method of claim 1, further comprising:
detecting, via a value input device, a physical item associated with a monetary value that establishes a monetary balance; and
dispensing, via a value output device, a payout in response to a cashout input that initiates a payout from the monetary balance.

9. The method of claim 1, wherein the plurality of transformed symbol instances consists of exactly two transformed symbol instances, each presented with a respective value based on a value of the at least one landed designated value-bearing symbol.

10. The method of claim 1, wherein the progressing award meter is presented as a visible jackpot display that dynamically updates upon the incrementing.

11. A gaming system comprising:
a presentation assembly configured to present a plurality of reels within an array and a progressing award meter, the plurality of reels bearing a plurality of symbols, the plurality of symbols including one or more designated value-bearing symbols; and
game-logic circuitry configured to perform the operations of:
initiating a hold-and-respin bonus feature in response to a trigger condition, the hold-and-respin bonus feature including a number of respins;
during a respin of the hold-and-respin bonus feature:
spinning and stopping at least a subset of the plurality of reels to land symbols from the plurality of symbols in the array; and
in response to landing at least one designated value-bearing symbol:
if at least one landed designated value-bearing symbol transforms into a plurality of transformed symbol instances, the plurality of transformed symbol instances including at least a first transformed symbol instance and a second transformed symbol instance, causing the presentation assembly to display the first transformed symbol instance and the second transformed symbol instance in the array;
incrementing the progressing award meter by a value portion associated with at least one of the at least one landed designated value-bearing symbol, the first transformed symbol instance, or the second transformed symbol instance; and
holding the at least one landed designated value-bearing symbol and any of the transformed symbol instances in their positions in the array for subsequent respins of the hold-and-respin bonus feature; and
causing the presentation assembly to present an award based at least in part on values associated with all of the designated value-bearing symbols and the transformed symbol instances held in the array at the conclusion of the hold-and-respin bonus feature.

12. The gaming system of claim 11, wherein the second transformed symbol instance is visually distinguishable from the first transformed symbol instance, and wherein the game-logic circuitry is configured to increment the progressing award meter by a value portion specifically associated with the second transformed symbol instance.

13. The gaming system of claim 11, wherein the game-logic circuitry is further configured to reset a respin counter for the hold-and-respin bonus feature in response to landing the at least one designated value-bearing symbol or a transformed symbol instance thereof.

14. The gaming system of claim 11, wherein the game-logic circuitry is further configured to: cause the presentation assembly to display a collection meter; and increment the collection meter in response to collecting a predetermined type or number of symbols, the predetermined type or number of symbols including the first transformed symbol instance.

15. The gaming system of claim 11, wherein the game-logic circuitry is further configured to: in response to landing a special feature-trigger symbol during the hold-and-respin bonus feature:
initiate a secondary bonus feature;
during the secondary bonus feature, enable incrementing of the progressing award meter based on symbols landed in the secondary bonus feature; and
cause the presentation assembly to award an amount displayed on the progressing award meter if a predetermined fill condition is achieved in the secondary bonus feature.

16. The gaming system of claim 11, wherein whether the at least one landed designated value-bearing symbol transforms is based on a random determination executed by the game-logic circuitry or a predefined characteristic of the at least one landed designated value-bearing symbol stored in a memory.

17. The gaming system of claim 11, wherein the gaming system includes a value input device and a value output device, and wherein the game-logic circuitry is further configured to perform the operations of:
detecting, via the value input device, a physical item associated with a monetary value that establishes a monetary balance; and
dispensing, via the value output device, a payout in response to a cashout input that initiates a payout from the monetary balance.

18. The gaming system of claim 11, wherein the plurality of transformed symbol instances consists of exactly two transformed symbol instances, and wherein the presentation assembly is configured to display each of the exactly two transformed symbol instances with a respective value based on a value of the at least one landed designated value-bearing symbol.

19. The gaming system of claim 11, wherein the presentation assembly is configured to display the progressing award meter as a visible jackpot display that dynamically updates when the game-logic circuitry increments the progressing award meter.

20. The gaming system of claim 11, wherein the game-logic circuitry is further configured to animate a transformation of the at least one landed designated value-bearing symbol into the plurality of transformed symbol instances, the animation including visually depicting an emergence of the first transformed symbol instance and the second transformed symbol instance from the at least one landed designated value-bearing symbol.
